(19) United States
(12) Patent Application Publication
(10) Pub. No.: US 2026/0116575 A1
(43) Pub. Date: Apr. 30, 2026

(54) Aircraft Tugs

(71) Applicants: Prisca Pondorfer, Tyrol (AT); Viola Pondorfer, Tyrol (AT)

(72) Inventors: Prisca Pondorfer, Tyrol (AT); Viola Pondorfer, Tyrol (AT)

(21) Appl. No.: 19/474,262

(22) PCT Filed: Apr. 18, 2024
(86) PCT No.: PCT/EP2024/060629

§ 371 Date: Oct. 10, 2025

(30) Foreign Application Priority Data
Apr. 19, 2023 (GB) 2305767.2

(51) Int. Cl. B64F 1/225

(52) U.S. Cl. CPC B64F 1/226

(57) ABSTRACT

An aircraft tug comprises a steerable forklift device that is powered for travel in a forwards and backwards direction and has a pair of forks that can be raised and lowered, the tug further comprising an adapter that is secured between the forks to provide spaced abutments for a wheel such that, in use, the forks can be positioned at opposite sides of an aircraft wheel with the abutments fore and aft of the wheel, whereby the wheel may be lifted by the forklift device and then moved by powered travel of the forklift device.

### CROSS-REFERENCE TO RELATED APPLICATIONS

This is the U.S. National Stage entry of International Application No. PCT/EP2024/060629, filed Apr. 18, 2024, which claims priority to GB Application No. 2305767.2, filed Apr. 19, 2023. These prior applications are incorporated herein by reference in their entirety.

### FIELD

The present invention relates to aircraft tugs-that is, devices that are intended for use in moving aircraft that are otherwise stationary, on the ground.

Various aircraft tugs have been proposed, including those for light aircraft. It is often required to move light aircraft in and out of hangers and to reposition them. Although light aircraft are typically wheeled, some physical effort is required in moving them manually and difficulty can be encountered in positioning them.

Known aircraft tugs are generally custom-designed to engage the nosewheel of an aircraft. Typically, they may be powered by electric motors. As they are custom designed for this particular purpose, they tend to be expensive.

### SUMMARY

Preferred embodiments of the present invention aim to provide aircraft tugs that are easy and effective to use and may be produced more economically.

According to one aspect of the present invention, there is provided an aircraft tug comprising a steerable forklift device that is powered for travel in a forwards and backwards direction and has a pair of forks that can be raised and lowered, the tug further comprising an adapter that is secured between the forks to provide spaced abutments for a wheel such that, in use, the forks can be positioned at opposite sides of an aircraft wheel with the abutments fore and aft of the wheel, whereby the wheel may be lifted by the forklift device and then moved by powered travel of the forklift device.

Preferably, the adapter is removably secured between the forks such that, upon removal, the forklift device can be used as a normal forklift device without the adapter in place.

Preferably, said abutments comprise a fixed, fore abutment and a removable, aft abutment.

Preferably, the adapter is formed with one or more guide to position one or both of said abutments within the adapter.

Preferably, the adapter is formed with a plurality of guides to provide alternative positions of at least one of said abutments within the adapter.

Preferably, one or both of said abutments is or are curved.

Preferably, the forklift device provides powered lift of its forks.

Preferably, the forklift device is electrically powered.

Preferably, the spacing between the forks of the forklift device is adjustable.

The invention extends to the adapter of an aircraft tug according to any of the preceding aspects of the invention.

In another aspect, the invention provides a method of converting a forklift device to an aircraft tug according to any of the preceding aspects of the invention, comprising the step of securing the adapter between the forks of the forklift device.

In a further aspect, the invention provides a method of moving an aircraft, comprising the steps of positioning at opposite sides of a wheel of the aircraft the forks of an aircraft tug according to any of the preceding aspects of the invention, with the abutments fore and aft of the wheel, lifting the wheel by the forklift device and then moving the wheel of the aircraft by powered travel of the forklift device.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 illustrates a powered forklift device in perspective view;

FIG. 2 is a perspective partial view of an adapter fitted to the forklift device of FIG. 1;

FIG. 3 is a simplified plan view of the adapter of FIG. 2 fitted to the forklift device of FIG. 1;

FIG. 4 illustrates in longitudinal section the adapter of FIGS. 2 and 3 fitted to forklift forks; and

FIG. 5 is a view similar to FIG. 4, showing an aircraft wheel engaged with the adapter.

### DESCRIPTION

In the figures, like references denote like or corresponding parts.

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

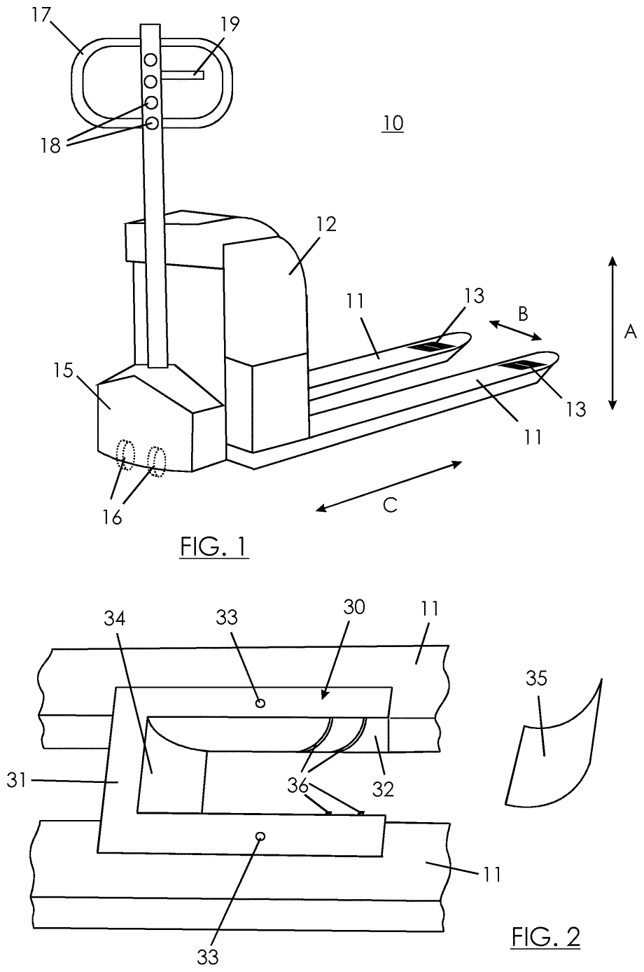

The powered forklift device 10 shown in FIG. 1 is typical of many such devices that are readily available for lifting and transporting various loads. Such devices are often referred to as pallet trucks, since they are widely used for transporting pallets. Typically, the forklift device 10 is electrically powered, although alternative power is possible.

Forks 11 are carried by a powered lifting unit 12 such that they may be raised and lowered as indicated by arrow A. The mutual spacing of the forks 11 may be varied, as indicated by arrow B. Rollers 13 are provided at forward ends of the forks 11.

A powered drive unit 15 provides drive via ground-engaging wheels 16 such that the forklift device 10 can travel backwards and forwards as indicated by arrow C.

An operator controls operation of the forklift device 10 by means of a handle 17 on which control buttons and lever 18, 19 are mounted. The handle 17 may be pivoted in order to steer the forklift device 10.

Such forklift devices and their operation will be well known to the skilled reader, and are therefore not described in further detail. It may be noted, however, that such devices are very widely available at competitive prices.

FIG. 2 shows an adapter 30 fitted to the forklift forks 11. The adapter 30 may be of any suitable material. It may be conveniently fabricated from steel or other metal. The adapter 30 has an upper section 31 of rectangular U-shape that engages the upper faces of the forks 11 and side walls 32 that engage the inner side faces of the forks 11. Removable bolts 33 secure the upper section 31 to the forks 11, such that the adapter 30 may be secured to the forks 11 and removed from them, as desired.

The adapter 30 comprises two curved abutment plates 34, 35 that, in use, face one another. The abutment 34 may be regarded as a fore abutment and, in this example, is secured permanently to the adapter 30, although it could be removable. The abutment 35 may be regarded as an aft abutment and is removable. In use, it engages an opposing pair of curved guides 36 that locate it in an operative position. In this example, there are two pairs of opposing curved guides 36, each pair spaced from the other, to provide two alternative positions to locate the aft abutment 35.

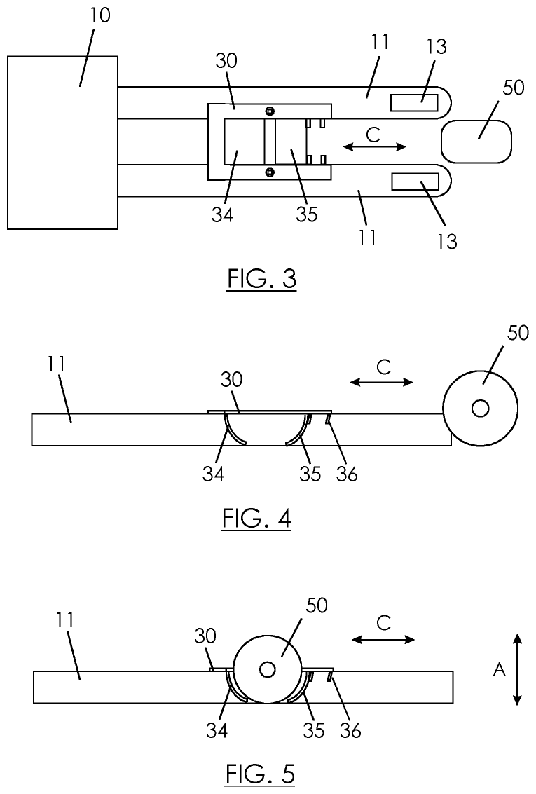

The adapter 30 converts the conventional forklift device 10 into an aircraft tug. Its mode of operation can be seen in FIGS. 3 to 5.

In FIGS. 3 and 4, the adapter 30 is secured to the forks 11 and the forklift device 10 is positioned in line with the nosewheel 50 of an aircraft to be moved or repositioned. For ease of explanation, the aft abutment 35 is shown in position, engaged with the forward guides 36. However, to engage the aircraft tug with the nosewheel 50, the aft abutment 35 is removed. The forklift device 10 is then driven towards the nosewheel 50 until the fore abutment 34 engages the nosewheel 50. At this point, the aft abutment 35 is placed in position, engaging the respective pair of guides 36.

FIG. 5 illustrates this condition, with the nosewheel 50 engaged within the adapter 30, between the fore and aft abutments 34, 35. The forklift device 10 is then actuated to lift the forks 11. This need be by only a small amount, sufficient to raise the nosewheel 50 from the ground. The forklift device 10 may then be actuated to move the nosewheel 50—and therefore the aircraft to which it is attached—forwards and backwards, the pivotable handle 17 providing steering.

Thus, power-assisted movement and positioning of an aircraft may be provided in an effective and economical way. As noted, the forklift device 10 may readily be obtained at a competitive price. The adapter 30 is relatively simple and economical to manufacture. In addition to providing an aircraft tug at a very attractive price, this embodiment of the invention allows full use of the forklift device 10 for other purposes, simply by removing the adapter 30.

The aft abutment 35 may be provided with a handle for ease of use, as may the fore abutment 34, if removable. One or more of the abutments 34, 35 may be plane (e.g. inclined) rather than curved. They need not be in plate form.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. An aircraft tug comprising a steerable forklift device that is powered for travel in a forwards and backwards direction and has a pair of forks that can be raised and lowered, the tug further comprising an adapter that is secured between the forks to provide spaced abutments to support an aircraft wheel such that, in use, the forks can be positioned at opposite sides of the aircraft wheel with the abutments fore and aft of the aircraft wheel, whereby the aircraft wheel may be lifted by the forklift device and then moved by powered travel of the forklift device, wherein the adapter is removably secured between the forks such that, upon removal, the forklift device can be used as a normal forklift device without the adapter in place, wherein said abutments comprise a fixed, fore abutment and a removable, aft abutment, wherein the adapter is formed with one or more guide to position one or both of said abutments within the adapter, and both of said abutments are curved to engage the aircraft wheel.

17. The aircraft tug of claim 16, wherein the adapter is formed with a plurality of guides to provide alternative positions of at least one of said abutments within the adapter.

18. The aircraft tug of claim 16, wherein the forklift device provides powered lift of its forks.

19. The aircraft tug of claim 16, wherein the forklift device is electrically powered.

20. The aircraft tug of claim 16, wherein the spacing between the forks of the forklift device is adjustable.

21. A method of converting a forklift device to the aircraft tug of claim 16, comprising the step of securing the adapter between the forks of the forklift device.

22. A method of moving an aircraft, comprising the steps of positioning at opposite sides of a wheel of the aircraft the forks of the aircraft tug of claim 16, with the abutments fore and aft of the aircraft wheel to support the aircraft wheel, lifting the aircraft wheel by the forklift device and then moving the aircraft wheel of the aircraft by powered travel of the forklift device.
